(19) United States
(12) Patent Application Publication
(10) Pub. No.: US 2026/0253131 A1
(43) Pub. Date: Aug. 27, 2026

(54) VIRTUAL GARMENT FITTING AND SHOPPING SYSTEM

(71) Applicant: Daryl Rogers, Shaker Heights, OH (US)

(72) Inventor: Daryl Rogers, Shaker Heights, OH (US)

(21) Appl. No.: 19/545,152

(22) Filed: Feb. 20, 2026

Related U.S. Application Data
(60) Provisional application No. 63/762,811, filed on Feb. 25, 2025.

(51) Int. Cl. G06Q 30/0601; G06F 3/01; G06T 7/50

(52) U.S. Cl. CPC G06Q 30/06432; G06F 3/011; G06F 3/016; G06Q 30/0631; G06Q 30/06442; G06Q 30/06444; G06T 7/50; G06T 2207/10028; G06T 2207/10048; G06T 2207/30196

(57) ABSTRACT

A virtual garment fitting and social shopping system is described. The system includes a software application operating with an infrared depth-capture device, a biometric wristband, an AR/VR wearable display, and a wireless navigation controller to generate a posture-corrected, measurement-accurate 3D avatar of a user. A cloud server performs volumetric reconstruction, garment simulation, fit scoring, and automated retailer-storefront generation. A virtual assistant provides real-time scanning guidance, natural-language dialog, personalized size and style recommendations, and coordination of multi-user social shopping sessions. The system enables augmented-reality garment try-on with biometric correction, dynamic virtual-mall navigation, and interactive viewing of auto-generated storefronts. A virtual runway mode presents curated outfit sequences for the user’s avatar with mid-runway outfit switching. The integrated platform supports immersive shopping, accurate fit prediction, automated retail onboarding, and synchronized social interactions.

### CROSS-REFERENCE TO RELATED APPLICATION

The present application claims priority to, and the benefit of, U.S. Provisional Application No. 63/762,811 which was filed on February 25, 2025, and is incorporated herein by reference in its entirety.

### FIELD OF THE INVENTION

The present invention generally relates to immersive online retail environments. More specifically, the present invention relates to a multi-component virtual garment fitting and social shopping platform configured to generate measurement-accurate 3D avatars, enable digital try-on of garments, and provide interactive navigation of virtual mall environments enhanced with automated retailer storefront generation and AI-driven assistance. The invention comprises an integrated ecosystem that includes the ‘FitScan’ software application executed on a computing device and accessory devices such as the ‘FitKey’ infrared depth scanner for capturing volumetric body data, the ‘FitBand’ biometric wristband for providing posture-related inputs, the ‘FitNav’ joystick controller for virtual navigation, and the ‘FitLens’ AR/VR wearable device for immersive visualization. A cloud server architecture hosts an avatar engine, a fit-recommendation module, a retail-integration module, and a data store for generating avatars, simulating garment behavior, and constructing automated three-dimensional storefront interiors from retailer catalogs. In certain embodiments, the system further includes the ‘FitGuide’ virtual assistant, which provides scan coaching, natural-language dialog, personalized size and style recommendations, and coordination of multi-user social shopping sessions. The platform enables users to visualize how garments drape and fit on their precise body shapes and optionally incorporates runway presentation modes, shared shopping interfaces, and real-time store deployment to deliver a dynamic, interactive, and highly personalized digital shopping experience. Accordingly, the present disclosure makes specific reference thereto. Nonetheless, it is to be appreciated that aspects of the present invention are also equally applicable to other like applications, devices, and methods of manufacture.

### BACKGROUND

By way of background, online shopping has become a widely adopted and convenient alternative to traditional in-store retail experiences. However, despite the popularity of online shopping, limitations remain in the consumer’s ability to accurately evaluate the fit, appearance, and suitability of clothing items before purchase. Historically, shoppers were able to try on garments in physical stores, enabling them to immediately determine whether an item fit properly and suited their body shape, style, and comfort preferences. The process inherently reduced uncertainty and minimized the likelihood of selecting improperly fitting clothing.

In contrast, online retail environments provide only static product images, generalized sizing charts, and broad fit descriptions that fail to capture the unique variations in individual body shapes. As a result, customers often rely on guesswork when selecting sizes, leading to a high probability of receiving garments that do not fit as expected. When clothing arrives and fits poorly, consumers are forced to return the items through postal mail or package drop-off services, creating inconvenience, delay, and frustration. The returns contribute to increased financial burdens for retailers and reduced satisfaction for customers, particularly when multiple rounds of exchanges are necessary.

Furthermore, conventional online shopping interfaces do not provide users with an accurate visualization of how a garment will drape, stretch, or conform to their specific body proportions. Product photos and model images cannot replicate the user’s individual physique, leaving consumers uncertain about how the clothing will appear on their own bodies. The disconnect between physical reality and digital representation continues to be a primary barrier to customer confidence and is a major source of the widespread fit-related returns that affect the apparel industry. Accordingly, individuals desire a system that enables users to visualize clothing on accurate digital representations of their own bodies, reducing guesswork and improving overall fit confidence.

Therefore, there exists a long-felt need in the art for a virtual garment fitting and shopping system that overcomes the persistent limitations of conventional online apparel purchasing. There is a long-felt need for a system that enables users to accurately visualize how garments will appear and fit on their unique body shapes, rather than relying on generic product photos or imprecise size charts. Additionally, there exists a need for a system that eliminates the inconvenience, cost, and repeated trial-and-error associated with returning improperly fitting clothing purchased online. Moreover, there is a need for a system that integrates real-time body scanning, biometric correction, and immersive visualization to minimize fit uncertainty and improve consumer confidence. Finally, there is a need for a platform that merges accurate fit prediction with social, interactive, and experiential shopping features to replicate the advantages of in-store try-on experiences.

The subject matter disclosed and claimed herein, in one embodiment, comprises a virtual garment fitting and social shopping system configured to generate measurement-accurate 3D avatars, provide digital or virtual garment try-on experiences, enable multi-user virtual mall exploration, and automate retailer storefront creation. The system includes the ‘FitScan’ software application executed on a computing device and configured to communicate with multiple accessory devices, including the ‘FitKey’ infrared depth scanner, the ‘FitBand’ biometric wristband, the ‘FitNav’ joystick controller, and the ‘FitLens’ AR/VR wearable headset. The cloud server includes functional modules such as an avatar engine, a fit recommendation module, a retail integration module, a data store, and a monetization engine. A multimodal virtual assistant, ‘FitGuide’, provides scanning guidance, size and style recommendations, natural-language dialog interaction, and orchestration of social shopping sessions. The system assembles posture-corrected volumetric body models, simulates garment drape behavior, and renders immersive mall, storefront, and runway environments to deliver a realistic and interactive shopping experience that mirrors or exceeds in-store try-on.

In one embodiment, the system enables augmented-reality garment try-on and avatar-based visualization through the ‘FitLens’ AR/VR wearable device, generating real-time overlays that align with the user’s physical body or with a high-resolution avatar. In another embodiment, the ‘FitGuide’ assistant curates personalized runway presentations, recommending sequential outfits based on user preferences, biometric profiles, and garment simulation results. The retail integration module may further convert retailer product catalogs into interactive, three-dimensional storefronts and automatically (i.e., autonomously) deploy them within the virtual mall, enabling rapid onboarding without manual 3D modeling.

In this manner, the virtual garment fitting and social shopping system of the present invention overcomes long-standing deficiencies in the art by providing an accurate, personalized, and immersive alternative to traditional online apparel shopping. The invention reduces improper sizing, minimizes return rates, and dramatically improves user confidence by combining infrared body scanning, biometric posture correction, garment simulation, and AI-driven guidance. The integrated virtual mall and automated retailer storefront generator create scalable commercial environments, while the runway mode and social shopping features introduce entertainment and human connection absent in prior systems.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a virtual garment fitting and social shopping system that includes a software application executed on a computing device and configured to present user interfaces for body scanning, avatar creation, digital or virtual garment try-on, virtual mall navigation, social shopping, and runway presentation. The system further incorporates an infrared depth-capture device designed to emit infrared projection patterns and collect depth frames representing the user’s body, and to transmit corresponding depth data to the software application. A biometric wristband generates posture-related data that is transmitted to the software application. A wearable augmented-reality or virtual-reality headset displays avatars, garments, and virtual mall environments, and exchanges spatial-tracking data and rendering instructions with the software application. A wireless joystick controller provides navigation input for interacting with the virtual mall and virtual storefronts.

The system further includes a cloud server communicatively coupled to the software application, where the cloud server hosts an avatar engine for generating a measurement-accurate avatar based on the depth and posture data, a fit-recommendation module for analyzing garment metadata and generating fit scores and size recommendations, a retail-integration module for converting retailer catalogs into three-dimensional storefront inventories and automatically (i.e., autonomously) generating virtual storefronts within the virtual mall, a data store for maintaining avatars, garment assets, retailer metadata, and session records, and a monetization engine for processing purchases made through the virtual storefronts.

In a further embodiment, a virtual assistant is executed by the software application or the cloud server and provides real-time scanning guidance based on depth and posture inputs, generates personalized outfit recommendations from the fit-recommendation module outputs, presents natural-language dialog during avatar creation, mall navigation, and garment try-on, and coordinates multi-user social shopping sessions by synchronizing avatar actions, user interactions, and contextual feedback.

In still another embodiment, the software application is additionally configured to render a virtual runway environment in which the avatar presents a curated outfit sequence generated by the virtual assistant and to receive mid-runway outfit-swap commands from the joystick controller. The retail-integration module deploys the automatically (i.e., autonomously) generated virtual storefronts into the virtual mall together with analytics-tracking metadata for monitoring engagement and performance.

In one aspect, the invention provides a virtual-assistant system integrated into a virtual garment fitting and social shopping platform. The system includes a mobile or wearable software application that communicates with an infrared depth-capture device, a biometric wristband, an AR/VR wearable display, and cloud-based processing modules. The virtual assistant receives depth frames and posture-related biometric data, evaluates scan-quality metrics such as coverage completeness and motion stability, and provides real-time corrective prompts to guide the user through accurate body-scanning. The assistant also generates personalized garment-size and style recommendations using outputs from a cloud-based fit-recommendation engine and provides a natural-language dialog interface for requesting styling help, outfit alternatives, and navigational guidance. Additionally, the virtual assistant coordinates multi-user social shopping sessions by synchronizing avatars, relaying group feedback, and presenting contextual insights during collaborative shopping activities.

In another aspect, the invention provides a virtual runway presentation system that enables users to showcase garments on a measurement-accurate avatar within an immersive fashion-show environment. The system includes a software application, a cloud-based avatar engine, an AR/VR wearable display, and a wireless joystick controller. The system renders a virtual runway scene complete with dynamic lighting, sound effects, and animated camera angles, and displays curated outfits generated by the virtual assistant on the user’s avatar. The system further enables real-time control of the runway sequence, enabling the user to swap outfits, adjust pacing, and trigger presentation transitions using the joystick controller. Atmospheric elements of the runway environment may be automatically (i.e., autonomously) adjusted based on outfit changes, garment characteristics, or virtual-assistant curation.

In another aspect, the invention provides an automated storefront-generation system that enables retailers to create virtual stores inside a virtual mall environment. The system includes a software application and a cloud-based retail-integration module configured to receive retailer catalog data such as images, metadata, sizing information, and three-dimensional garment assets. The catalog is automatically (i.e., autonomously) converted into a three-dimensional store inventory using taxonomy mapping, mesh generation, rack assignment, and merchandising rules. The system generates a complete virtual storefront including brand themes, signage, and interactive product displays. The retail-integration module further identifies and resolves catalog errors such as missing metadata or incompatible assets and deploys the final storefront into the virtual mall together with analytics-tracking identifiers for monitoring user engagement and inventory performance.

In another aspect, the invention provides a virtual mall integration system that renders multi-store corridors, brand-labeled storefronts, live garment previews, and store interiors within a navigable digital shopping environment. The system receives navigation inputs from a wireless joystick controller, gesture inputs from an AR/VR device, or touchscreen inputs from a mobile application. As users explore the mall, the system dynamically generates storefronts using cloud-hosted retail-integration modules and presents AR garment overlays or avatar-based previews. The system retrieves and displays detailed store interiors, live product previews, and shopping pathways. A virtual assistant analyzes user behavior, fit results, and browsing context to provide contextual recommendations such as suggested stores, style categories, or navigation cues presented through voice, chat, or visual overlays.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a system architecture for virtual garment fitting and social shopping system according to various embodiments of the present invention;

FIG. 2 illustrates the cloud-based server architecture used in the system of the present invention in accordance with the disclosed structure;

FIG. 3 illustrates a flow diagram depicting steps of an avatar-creation process performed by the virtual garment fitting and social shopping system of the present invention in accordance with the disclosed structure;

FIG. 4 illustrates a flow diagram of one embodiment of a virtual mall navigation process executed by the virtual garment fitting and social shopping system of the present invention;

FIG. 5 illustrates an exemplary virtual-assistant processing flow for providing personalized fashion guidance and dialog interaction within the virtual garment fitting and social shopping system of the present invention;

FIG. 6 illustrates a flow diagram depicting process flow of virtual runway presentation mode executed within the virtual garment fitting and social shopping system of the present invention in accordance with the disclosed structure;

FIG. 7 illustrates a flow diagram representing an automated storefront generation process performed by the virtual garment fitting and social shopping system of the present invention in accordance with the disclosed architecture;

FIG. 8 illustrates a flow diagram depicting multi-function workflow performed by the ‘FitGuide’ virtual assistant within the virtual garment fitting and social shopping system of the present invention;

FIG. 9 illustrates a flow chart depicting steps of a transaction-processing workflow executed by the virtual garment fitting and social shopping system in accordance with the disclosed architecture;

FIG. 10 illustrates a flow diagram depicting operational workflow of the virtual garment fitting and social shopping system of the present invention in accordance with the disclosed architecture;

FIG. 11 illustrates an exemplary application entry interface displayed to a user on launching the ‘FitScan’ App in accordance with the disclosed architecture;

FIG. 12 illustrates one embodiment of an avatar-creation user interface displayed within the ‘FitScan’ application (i.e., App) in accordance with the disclosed architecture;

FIG. 13 illustrates an exemplary social shopping interface displayed by the ‘FitScan’ software application (i.e., App) in accordance with the disclosed architecture;

FIG. 14 illustrates one embodiment of an automated storefront-builder interface presented within the software application for enabling retailers to quickly configure and publish virtual storefronts inside the virtual mall environment;

FIG. 15 illustrates one embodiment of a virtual runway presentation interface generated by the ‘FitScan’ system of the present invention during operation of the runway mode; and

FIG. 16 illustrates one embodiment of a body-measurement capture interface generated by the ‘FitScan’ system during the scanning and avatar-creation process.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a virtual garment fitting and shopping system that overcomes the persistent limitations of conventional online apparel purchasing. There is a long-felt need for a system that enables users to accurately visualize how garments will appear and fit on their unique body shapes, rather than relying on generic product photos or imprecise size charts. Additionally, there exists a need for a system that eliminates the inconvenience, cost, and repeated trial-and-error associated with returning improperly fitting clothing purchased online. Moreover, there is a need for a system that integrates real-time body scanning, biometric correction, and immersive visualization to minimize fit uncertainty and improve consumer confidence. Finally, there is a need for a platform that merges accurate fit prediction with social, interactive, and experiential shopping features to replicate the advantages of in-store try-on experiences.

The present invention, in one exemplary embodiment, is a virtual-assistant system integrated into a virtual garment fitting and social shopping platform. The system includes a mobile or wearable software application that communicates with an infrared depth-capture device, a biometric wristband, an AR/VR wearable display, and cloud-based processing modules. The virtual assistant receives depth frames and posture-related biometric data, evaluates scan-quality metrics such as coverage completeness and motion stability, and provides real-time corrective prompts to guide the user through accurate body-scanning. The assistant also generates personalized garment-size and style recommendations using outputs from a cloud-based fit-recommendation engine and provides a natural-language dialog interface for requesting styling help, outfit alternatives, and navigational guidance. Additionally, the virtual assistant coordinates multi-user social shopping sessions by synchronizing avatars, relaying group feedback, and presenting contextual insights during collaborative shopping activities.

Reference will now be made in detail to the present preferred embodiments of the invention, examples of which are illustrated in the accompanying drawings. Wherever possible, the same reference numerals are used in the drawings and the description to refer to the same or like parts.

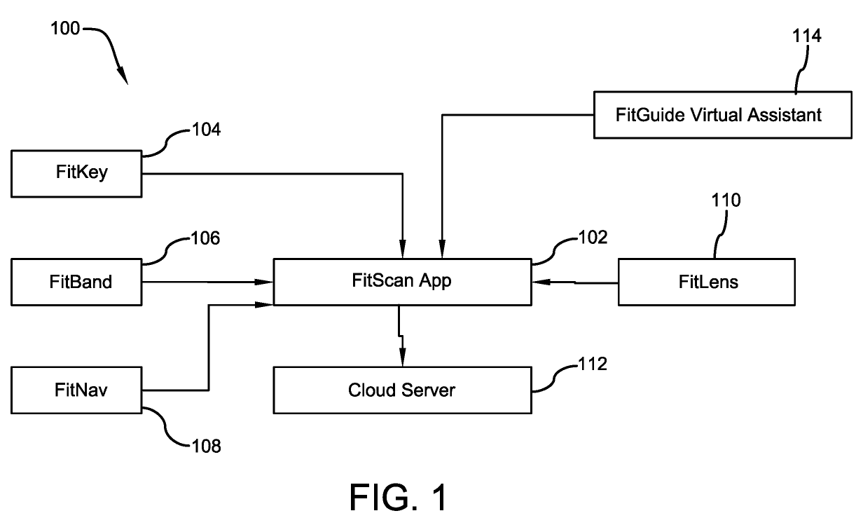

Referring initially to the drawings, FIG. 1 illustrates a system architecture for virtual garment fitting and social shopping system according to various embodiments of the present invention. The system 100 enables users to generate measurement-accurate 3D avatars, perform digital or virtual garment try-on, navigate virtual mall environments, participate in shared multi-user shopping sessions, and interact with real-world retail storefronts through automated storefront integration. As shown in FIG. 1, the system 100 includes a software application 102 (referred to herein as the “‘FitScan’ App”), one or more accessory devices including a ‘FitKey’ infrared scanner 104, a ‘FitBand’ biometric wristband 106, a ‘FitNav’ joystick or navigational controller 108, a ‘FitLens’ AR/VR wearable device 110, and a cloud server 112.

In various embodiments, the ‘FitScan’ App 102 can be executed on a mobile electronic device, tablet computer, laptop, smart mirror, AR visor, VR headset, or other computing platform having one or more processors, memory, network interfaces, sensors, and a display. The ‘FitScan’ App 102 is configured to provide multiple user interfaces for body-scanning, avatar creation, garment try-on, virtual mall navigation, social shopping, and runway presentation modes. The software application 102 can communicate with the ‘FitKey’ 104, ‘FitBand’ 106, ‘FitNav’ 108, and ‘FitLens’ 110 using one or more communication protocols including, but not limited to, Bluetooth Low Energy (BLE), Wi-Fi, NFC, ultra-wideband (UWB), near-field infrared signaling, or combinations thereof. In some embodiments, the software application 102 synchronizes sensor data using timestamps, packet-level metadata, or low-latency compression techniques to improve accuracy during 3D scanning and AR rendering.

The infrared scanner 104, also referred to herein as the ‘FitKey’ infrared scanner, can be configured as a handheld, tripod-mounted, or environmental-mounted infrared depth-capture device. In some embodiments, the infrared scanner 104 emits or captures structured-light projection patterns, time-of-flight depth pulses, or speckle-pattern illumination to capture depth images, volumetric slices, or point-cloud frames at distances between approximately 0.5 m and 3.0 m. The infrared scanner 104 can internally include an IR emitter, IR camera, calibration module, inertial sensor, and microcontroller configured to perform preliminary depth fusion, noise filtering, and frame bundling before transmitting data to the ‘FitScan’ App 102.

The ‘FitKey’ infrared scanner 104 can transmit data to the ‘FitScan’ App 102 using BLE, Wi-Fi, or hybrid communication modes. The scanner 104 can be configured to report diagnostic metrics including temperature, battery level, calibration status, and IR exposure parameters. The software application 102 can provide configuration commands, firmware updates, or scan-mode selection signals to the scanner 104. In some embodiments, the ‘FitKey’ 104 automatically (i.e., autonomously) pauses or resumes capture based on user motion, occlusion, or ‘FitBand’ posture signals.

The biometric wristband 106, also referred to as the ‘FitBand’, is a wearable device configured to transmit posture-related and physiological data to the ‘FitScan’ App 102. The ‘FitBand’ 106 can include a 6-axis inertial measurement unit (IMU), magnetometer, photoplethysmography (PPG) sensor, skin-temperature sensor, or galvanic skin-response sensor. The posture-related output of the ‘FitBand’ 106 can include skeletal-alignment vectors, wrist orientation, and motion-stability indicators. The information may be used by the software application 102 to correct body-scan data for posture deviations, leaning, twisting, or other misalignment conditions during scanning.

In some embodiments, the ‘FitBand’ 106 includes haptic motors or LED indicators configured to provide tactile or visual feedback to the user during scanning, calibration, or avatar-recording sessions. The wristband 106 may also include automatic pairing capabilities, low-power modes, battery-health monitoring, and motion-detection mechanisms that help maintain consistent data quality for volumetric reconstruction.

The joystick navigation controller 108, also referred to herein as the ‘FitNav’ joystick, can be configured as a handheld wireless controller featuring a multi-axis joystick, one or more buttons, and haptic response elements. The ‘FitNav’ 108 enables user interaction with virtual mall environments, virtual retail storefronts, and social shopping rooms rendered by the ‘FitScan’ App 102 or the ‘FitLens’ AR/VR device 110. The ‘FitNav’ 108 can support user locomotion, selection inputs, gesture shortcuts, and runway-mode control inputs. In certain embodiments, ‘FitNav’ input data is transmitted to the software application 102 for local processing and simultaneously relayed to the cloud server 112 for multi-user synchronization.

The AR/VR wearable headset 110, also referred to as the ‘FitLens’ device, is configured to provide immersive visualization of avatars, digital or virtual garments, try-on overlays, and virtual mall environments. In various embodiments, the wearable headset 110 can include stereoscopic displays, head-pose tracking sensors, eye-tracking sensors, forward-facing cameras for passthrough AR, and hand-tracking modules. The ‘FitLens’ 110 can be configured to generate real-time occlusion masks, depth-aligned overlays, or avatar-anchored garment projections. In some embodiments, the ‘FitLens’ 110 communicates bidirectionally with the ‘FitScan’ App 102 to exchange rendering instructions, gesture data, spatial tracking information, and avatar state updates.

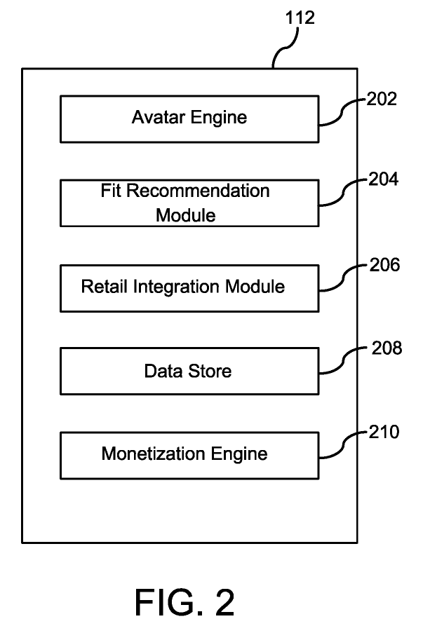

The cloud server 112 includes one or more cloud-based computing systems as described in FIG. 2 for avatar generation using parametric body models, volumetric fusion and mesh reconstruction of IR depth frames, garment simulation, cloth deformation, and fit scoring, user data storage, authentication, and analytics. The cloud server 112 exchanges data with the ‘FitScan’ App 102 to provide high-performance computation and persistent data storage in the system 100. The cloud server 112 can communicate with the ‘FitScan’ App 102 using encrypted communication protocols (e.g., HTTPS, TLS, WPA2) and can support caching mechanisms for frequently accessed assets such as garment models, avatar presets, and virtual mall environments.

In some embodiments, the cloud server 112 may offload only the computationally expensive portions of a workflow, while lightweight preprocessing may be performed locally on the ‘FitScan’ App 102 or the ‘FitLens’ 110. The hybrid processing model enables low-latency rendering on consumer devices while maintaining high-accuracy avatar and garment simulations.

The system 100 further includes an intelligent virtual assistant 114, referred to herein as the ‘FitGuide’ Virtual Assistant. The ‘FitGuide’ 114 is a multimodal digital assistant configured to provide real-time guidance, coaching, recommendations, and contextual automation across the complete ‘FitScan’ workflow. The ‘FitGuide’ 114 may also operate as a software subsystem executed by the ‘FitScan’ App 102, supplemented by cloud-based inference components executed on the cloud server 112. The ‘FitGuide’ 114 may ingest inputs from multiple system components, including scan-quality metrics from the ‘FitKey’ infrared scanner 104, posture vectors and biometric indicators from the ‘FitBand’ 106, navigation inputs from the ‘FitNav’ controller 108, and spatial-tracking or AR/VR context information from the ‘FitLens’ 110.

In some embodiments, the ‘FitGuide’ 114 includes one or more natural-language processing (NLP) modules configured to provide a conversational interface to the user. The ‘FitGuide’ 114 may deliver text-based prompts, voice-based instructions, visual indicators, or AR-anchored cues depending on the operating mode. During body scanning, for example, the ‘FitGuide’ 114 can analyze body-coverage completeness, motion blur, posture alignment, and depth-capture confidence, and may issue corrective prompts such as “stand slightly farther back,” “rotate left,” or “raise your arms to shoulder height” to ensure high-accuracy volumetric capture.

The ‘FitGuide’ 114 may further function as a personalized fit-recommendation engine, leveraging user measurements, garment metadata, historical fit scores, fabric stretch properties, virtual try-on results, and retailer-specific size charts to recommend an appropriate size or styling alternative. In some embodiments, the ‘FitGuide’ 114 may display explanations such as “Size M provides optimal shoulder alignment and recommended ease allowance,” thereby improving user trust and transparency. The ‘FitGuide’ 114 may additionally generate curated outfit sequences, mood boards, or lookbooks tailored to the user’s preferences, biometric profile, and prior shopping behavior.

Retailers may also interact with the ‘FitGuide’ 114 during storefront onboarding. The ‘FitGuide’ 114 may guide retailers through catalog uploads, taxonomy mapping, product-tag cleanup, template selection, and theme configuration within the automated storefront builder interface. The ‘FitGuide’ may detect missing metadata, improperly formatted assets, or inconsistent naming conventions, prompting the retailer to correct issues before publishing the storefront.

The ‘FitGuide’ 114 may be implemented as a hybrid of on-device inference and cloud-based processing. Lightweight intent classification, wake-word detection, or latency-critical feedback may run locally on the ‘FitScan’ App 102 or ‘FitLens’ 110 and computationally intensive operations that rely on large language models or deep-learning inference can be executed on the cloud server 112.

FIG. 2 illustrates the cloud-based server architecture used in the system of the present invention in accordance with the disclosed structure. As shown, the cloud server 112 includes a plurality of functional modules configured to support various functionalities such as avatar generation, garment simulation, retailer storefront automation, data storage, and monetization operations for the virtual garment fitting and social shopping system described with respect to FIG. 1.

The avatar engine 202 is configured to generate, refine, and update measurement-accurate user avatars based on depth data, mesh representations, and posture-corrected measurements received from the ‘FitScan’ App 102. In various embodiments, the avatar engine 202 performs operations such as volumetric fusion of depth frames, reconstruction of three-dimensional body meshes, optimization of parametric body models, and generation of facial and body textures. The avatar engine 202 may also create rigged and animated avatars suitable for use in virtual mall navigation, runway simulations, augmented-reality overlays, and social shopping sessions.

The fit recommendation module 204 is configured to analyze garment fit and determine size or style recommendations for the user’s avatar. The module 204 may receive garment metadata, fabric characteristics, sizing charts, and pre-processed garment meshes. Using the information, the module 204 may perform cloth simulation, stretch and ease analysis, drape modeling, and fit-scoring computations. In some embodiments, the fit recommendation module 204 generates explanatory outputs that inform the ‘FitGuide’ assistant of the system 100 of specific garment pressures, tension zones, or comfort indicators, enabling the system to provide context-aware, human-readable fitting advice.

The retail integration module 206 facilitates retailer onboarding, catalog ingestion, and automated storefront creation within the virtual mall environment. The retail integration module 206 may receive catalog files, including images, sizing metadata, and three-dimensional garment assets, and perform schema inference to classify products and map them to system-wide taxonomies. The retail integration module 206 may also construct virtual storefront interiors, render branded signage, manage inventory updates, and publish interactive store environments accessible through the ‘FitScan’ App 102 or ‘FitLens’ device 110. In some embodiments, the retail integration module 206 enables real-time updates to product listings and promotional content.

The data store 208 provides persistent storage for user avatars, garment assets, body measurements, session histories, retailer catalogs, and other data required by the system 100. In certain embodiments, the data store 208 can include multiple databases or storage tiers optimized for high-frequency request caching, archival retention, and secure handling of personally identifiable information.

The stored data may be encrypted and access-control is enabled on all the stored data. The data store 208 may further support rapid retrieval of frequently accessed content, thereby reducing latency during avatar rendering, virtual mall navigation, and real-time social interactions.

The monetization engine 210 is configured to support subscription management, transaction routing, usage metering, and payment processing for purchases made within the ‘FitScan’ system 100. The monetization engine 210 may interact with external payment gateways, process checkout events originating from virtual storefronts, calculate revenue shares for retailer partners, and maintain billing records for both consumers and retailers. In some embodiments, the monetization engine 210 supports tiered access models, in-app purchases, configurable transaction rules, and merchant analytics.

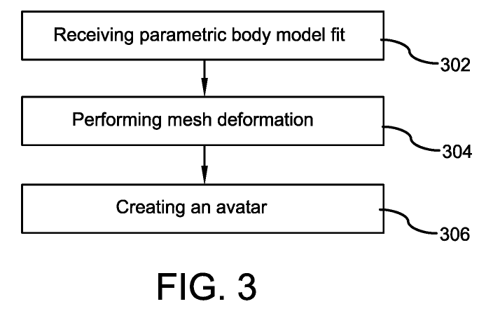

FIG. 3 illustrates a flow diagram depicting steps of an avatar-creation process performed by the virtual garment fitting and social shopping system of the present invention in accordance with the disclosed structure. Initially, the system 100 receives a parametric body model fit (Step 302). In various embodiments, the parametric body model fit may be derived from volumetric scan data, depth-frame fusion, measurement extraction, or a combination of body-shape estimation algorithms executed on the software application 102 or the cloud server 112.

The parametric body model fit can include numerical parameters defining body shape, joint spacing, limb proportions, torso curvature, or other anthropometric attributes that characterize physical geometry of a user.

In many embodiments, the system receives depth frames, measurement vectors, or fused scan data and generates a parametric body model fit using the avatar engine 202 running on the cloud server 112. However, in alternative configurations, the ‘FitScan’ App 102 may generate or partially generate the parametric model locally to reduce network latency. In certain AR-driven experiences, preliminary body-model estimation may also be performed directly on the ‘FitLens’ 110.

At step 304, the system 100 performs mesh deformation based on the received parametric body model. In some embodiments, the mesh deformation process includes applying deformation fields, linear blend skinning, corrective shape adjustments, rig weight recalibration, or optimization of vertex positions to produce a high-resolution avatar mesh. Mesh deformation may also include smoothing operations, surface-noise reduction, symmetry correction, and refinement of anatomical regions such as shoulders, hips, knees, or facial features. The deformation may be guided by machine-learning models trained on large-scale human-body datasets to ensure anatomical realism and garment-compatibility.

In some embodiments, the ‘FitScan’ App 102 performs partial mesh deformation (e.g., coarse warping, silhouette alignment) when operating in offline mode, low-connectivity environments, or preview states.

At step 306, the system creates an avatar based on the deformed mesh. The avatar can include a fully rigged 3D human model with articulated skeletal joints, animation controllers, texture layers, and clothing-simulation anchor points suitable for garment try-on. In some embodiments, the avatar may incorporate a facial model aligned to user imagery, skin-tone mapping, hair presets, or user-selected customization attributes. The generated avatar may be stored within the data store 208 for subsequent retrieval and used in virtual mall navigation, AR garment overlay via ‘FitLens’ 110, social shopping sessions, virtual runway presentations, and other features of the system.

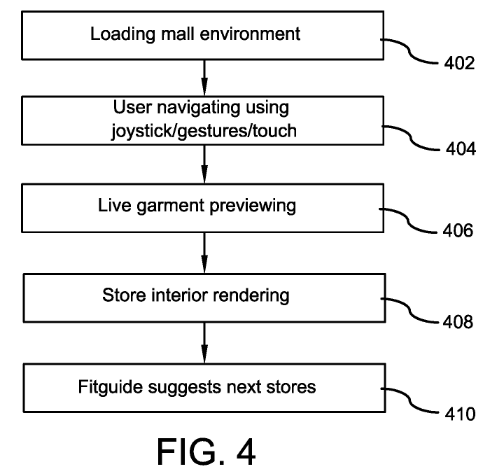

FIG. 4 illustrates a flow diagram of one embodiment of a virtual mall navigation process executed by the virtual garment fitting and social shopping system of the present invention. Initially, the system 100 loads a virtual mall environment (Step 402). In various embodiments, the mall environment can include multi-level corridors, brand-labeled storefronts, lighting effects, ambient audio, live promotional banners, and other immersive elements. The virtual mall assets may be retrieved from the data store 208 or generated dynamically by the retail integration module 206 based on retailer participation and real-time catalog updates.

At step 404, a user may navigate through the virtual mall environment using one or more input modalities. The navigation inputs can include joystick movements provided by the ‘FitNav’ controller 108, hand or body gestures detected by the ‘FitLens’ AR/VR device 110, touchscreen input from the ‘FitScan’ App 102, or a combination thereof. In some embodiments, navigation may also incorporate head pose data, gaze tracking, or motion-controller input, enabling both directional movement and item selection within the mall environment.

Then, the system 100 performs live garment previewing (Step 406). The process can include displaying 3D garments on the user’s avatar, providing AR garment overlays in real time through the ‘FitLens’ device 110, or rendering garment thumbnails and rack previews as the user approaches a storefront. Live garment previewing may be supported by the fit recommendation module 204, which evaluates garment suitability and automatically (i.e., autonomously) adjusts garment draping, sizing, and fit-score indicators as the user browses.

At step 408, the system 100 renders interior views of selected stores. In various embodiments, store interiors may be generated on demand by the retail integration module 206 and can include branded fixtures, digital clothing racks, product carousels, virtual mannequins, and interactive shelves. The interior environment may also incorporate lighting adjustments, proximity triggers, and dynamic animations to provide a realistic and immersive shopping experience. The rendering may occur locally on the ‘FitScan’ App 102, on the ‘FitLens’ 110 for AR/VR views, or remotely on the cloud server 112 for high-complexity assets.

During the rendering, the virtual assistant 114 may suggest additional stores, pathways, or product categories (Step 410) based on user behavior, preferences, past purchases, avatar characteristics, garment fit results, or social-session activity. The ‘FitGuide’ assistant 114 can analyze user navigation patterns, dwell time, fit feedback, and similarity scores between viewed and recommended garments to determine a ranked list of next-store suggestions. The suggestions may be presented through voice prompts, chat bubbles, highlight beacons within the mall corridor, or UI overlays in the ‘FitScan’ App 102.

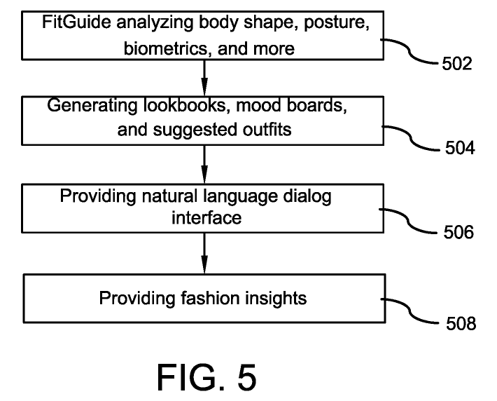

FIG. 5 illustrates an exemplary virtual-assistant processing flow for providing personalized fashion guidance and dialog interaction within the virtual garment fitting and social shopping system of the present invention. Initially, the ‘FitGuide’ assistant 114 can analyze body shape, posture, biometric data, and other user-specific characteristics (Step 502).

In various embodiments, the ‘FitGuide’ assistant 114 may obtain inputs such as parametric body-model parameters, posture and motion vectors transmitted by the ‘FitBand’ 106, garment fit evaluations provided by the Fit recommendation module 204, and physiological or contextual signals captured during the scanning and shopping experience. The analysis may involve applying machine-learning models trained on anthropometric datasets, fashion-compatibility heuristics, trend-matching algorithms, or biometric-alignment rules to determine suitable styling strategies for the user.

At step 504, the ‘FitGuide’ assistant 114 may generate lookbooks, mood boards, curated wardrobe sets, and suggested outfits. The generation process can include selecting garments that complement the user, posture profile, complexion, or observed style preferences.

In some embodiments, the ‘FitGuide’ assistant 114 may dynamically assemble thematic collections such as seasonal styles, event-appropriate outfits, and color-coordinated looks recommendations, to support immersive shopping experiences. The lookbooks may be displayed within the ‘FitScan’ App 102, rendered as AR overlays through the ‘FitLens’ 110, or shared during social shopping sessions.

At step 506, the system 100 can provide a natural-language dialog interface through which the user may interact with the ‘FitGuide’ assistant 114. The dialog interface may utilize speech recognition, text-based messaging, multimodal inputs, or gesture-triggered queries to enable users to request styling help, ask questions, browse outfit alternatives, or modify recommended looks.

In some embodiments, the ‘FitGuide’ assistant 114 can provide explanations for size recommendations, highlight garment-specific details, summarize shopping session activities, or assist with navigation within the virtual mall. The dialog interface may run locally on the ‘FitScan’ App 102 or may be supported by cloud-based natural-language models executed on the server 112.

The ‘FitGuide’ assistant 114 can provide fashion insights tailored to the user’s body geometry, preferences, past purchase history, and contextual factors (Step 508). In some embodiments, the insights may adapt dynamically as the user browses, changes garments, or interacts with other participants in social shopping sessions.

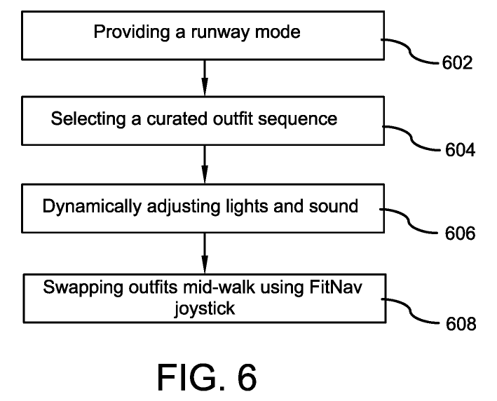

FIG. 6 illustrates a flow diagram depicting process flow of virtual runway presentation mode executed within the virtual garment fitting and social shopping system of the present invention in accordance with the disclosed structure. Initially, a runway mode is enabled such as on an input from a user (Step 602) that enables the user’s avatar to walk along a simulated catwalk presented within the ‘FitScan’ App 102, rendered through the ‘FitLens’ AR/VR device 110, or projected in mixed reality using passthrough cameras. The runway environment can include stage structures, directional lighting, background animations, audio effects, and dynamic crowd simulations to create an immersive fashion-show experience.

At step 604, a curated outfit sequence for presentation on the runway is selected. The curated sequence may be generated by the ‘FitGuide’ virtual assistant 114 based on user preferences, body-model parameters, seasonal trends, garment-fit scores, or retailer-specific merchandising rules.

In some embodiments, the curated sequence can include thematically organized outfits, color-coordinated sets, designer-specific collections, or automatically (i.e., autonomously) assembled lookbooks tailored to the user. The curated sequence may be retrieved from the data store 208 or assembled dynamically at runtime.

Then, the system dynamically adjusts lighting, sound, camera angles, and other atmospheric elements in synchronization with the outfit sequence (Step 606). The adjustments can include spotlight shifts, ambient light color changes, music transitions, environmental animations, or simulated crowd reactions designed to enhance the presentation.

In some embodiments, the lighting and sound may respond to garment properties such as texture, color, material reflectivity, or motion dynamics, thereby creating a personalized audiovisual experience for the user.

At step 608, the system enables the user to swap outfits mid-walk using the ‘FitNav’ joystick or navigational controller 108 or other input modalities (e.g., gestures, voice commands, touchscreen input). The ‘FitNav’ joystick may enable the user to trigger transitions between outfits, reverse the runway sequence, slow down or accelerate the avatar’s walking speed, or activate special visual effects.

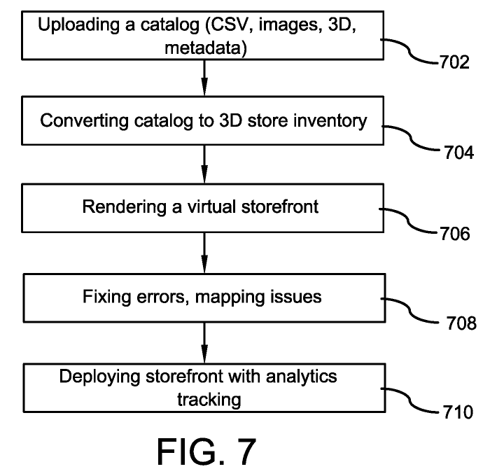

FIG. 7 illustrates a flow diagram representing an automated storefront generation process performed by the virtual garment fitting and social shopping system of the present invention in accordance with the disclosed architecture. Initially, a retailer uploads a product catalog to the system (Step 702).

In various embodiments, the catalog can include CSV files, images, three-dimensional garment models, product metadata, pricing information, category structures, sizing charts, color variants, or promotional assets. The uploaded materials may be received through a retailer dashboard, an API endpoint, or a one-click integration interface provided by the retail integration module 206.

Then, the system converts the uploaded catalog into a three-dimensional store inventory suitable for rendering within the virtual mall environment (Step 704). The conversion process can include mapping metadata fields to standardized categories, generating or adjusting 3D garment meshes, processing material textures, reconstructing multi-angle product imagery, and applying garment-simulation parameters used by the fit recommendation module 204.

In some embodiments, the system automatically (i.e., autonomously) assigns garments to virtual racks, shelving units, mannequins, or product carousels based on inferred product type, brand hierarchy, or retailer-specified merchandising rules.

At step 706, the system renders a virtual storefront using the constructed inventory. The storefront can include brand-specific themes, signage, color palettes, lighting styles, architectural layouts, and interactive product displays generated by the retail integration module 206. In some embodiments, the system generates multiple preview modes such as a consumer view, an AR overlay view, and a storefront owner’s administrative view, to enable retailers to inspect the visual appearance of their store prior to deployment. Storefront rendering may occur on the cloud server 112, on the ‘FitScan’ App 102, or on the ‘FitLens’ device 110 depending on device capability and rendering complexity.

At step 708, the system identifies and resolves errors or mapping issues detected during catalog conversion or storefront generation. The issues can include missing metadata fields, incompatible 3D asset formats, incorrect garment-category assignments, texture alignment problems, or structural inconsistencies in the storefront layout.

Finally, the system 100 deploys the storefront within the virtual mall environment along with embedded analytics tracking (Step 710). Deployed storefronts may be made accessible to users navigating the mall via the ‘FitScan’ App 102 or ‘FitLens’ 110. The analytics tracking can include metrics such as user visitation frequency, garment interactions, dwell time, outfit-preview counts, conversion rates, and inventory-level monitoring.

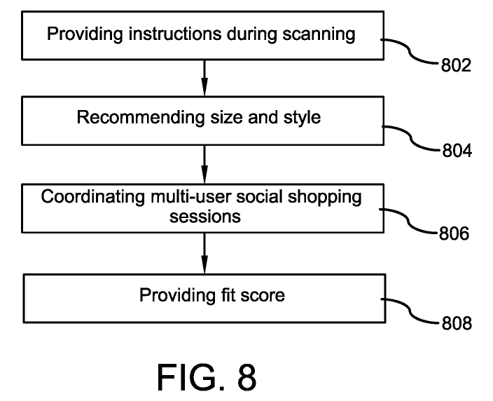

FIG. 8 illustrates a flow diagram depicting multi-function workflow performed by the ‘FitGuide’ virtual assistant within the virtual garment fitting and social shopping system of the present invention. Initially, the virtual assistant 114 provides instructions during scanning (Step 802).

In various embodiments, ‘FitGuide’ virtual assistant 114 may monitor scan coverage, body posture, device alignment, motion stability, and sensor confidence values received from the ‘FitKey’ infrared scanner 104 and the ‘FitBand’ biometric wristband 106. Based on the inputs, the assistant may deliver real-time corrective guidance, such as adjusting stance, rotating the body, or repositioning the device to ensure accurate depth capture and measurement extraction. The instructions may be provided through on-screen prompts, voice feedback, haptic alerts, or AR overlay indicators displayed through the ‘FitLens’ device 110.

At step 804, the ‘FitGuide’ assistant 114 recommends garment size and style. The recommendations may be generated using garment metadata, parametric body-model parameters, historical purchase data, and fit-scoring outputs produced by the fit recommendation module 204.

The ‘FitGuide’ assistant 114 may coordinate multi-user social shopping sessions (Step 806). The step can include establishing shared shopping rooms, synchronizing user positions within the virtual mall, managing real-time avatar presence indicators, and facilitating communication between participants.

In some embodiments, ‘FitGuide’ may summarize group feedback, highlight items viewed by friends, assist with shared lookbooks, or coordinate avatar movements during collaborative runway sessions. Synchronization may be supported through cloud-based messaging, CRDT state management, or WebRTC/MQTT communication protocols executed on server 112.

At step 808, the ‘FitGuide’ assistant 114 provides a fit score to the user. The fit score may be computed using pressure-mapping analysis, ease-distribution metrics, stretch simulations, garment-to-avatar collision detection, or drape-quality assessments. The ‘FitGuide’ assistant 114 may present the fit score in numerical, color-coded, textual, or graphical form, providing explanations for potential areas of tightness, looseness, or movement restriction.

It should be noted that the ‘FitGuide’ assistant 114 maintains privacy during interaction with the users. Privacy maintenance can include handling user consent, redacting personally identifiable information (PII), disabling face-texture sharing in group sessions, encrypting transmitted measurement data, and enforcing access-control rules for multi-user interactions.

In some embodiments, ‘FitGuide’ may automatically (i.e., autonomously) notify users when data is being shared, request explicit consent before enabling certain features, and restrict access to sensitive biometric information in accordance with system policies.

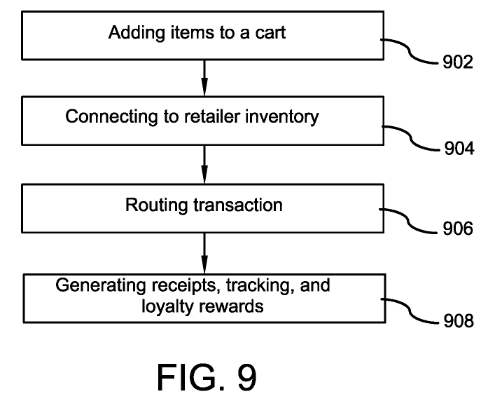

FIG. 9 illustrates a flow chart depicting steps of a transaction-processing workflow executed by the virtual garment fitting and social shopping system in accordance with the disclosed architecture. Initially, a user adds one or more items to a virtual shopping cart (Step 902).

The items can include garments, accessories, curated outfits, or bundled recommendations selected from the virtual mall, store interiors, or ‘FitGuide’-generated lookbooks. In various embodiments, items may be added through the ‘FitScan’ App 102, via AR selection using the ‘FitLens’ 110, or through multi-user interactions where friends suggest items during social shopping sessions.

At step 904, the user is connected to retailer inventory systems to verify stock availability, pricing, variant options, and promotional status. The connection may occur through APIs, retailer-provided webhooks, inventory-sync modules within the retail integration module 206, or real-time cloud endpoints.

At step 906, the system routes the transaction for processing. Transaction routing can include preparing an order payload, selecting an appropriate payment gateway, applying tax rules or shipping calculations, and forwarding encoded order details to the retailer’s commerce system. In some embodiments, the monetization engine 210 may handle payment authorization, fraud checks, loyalty-program integration, and purchase verification.

Finally, the system generates receipts, tracking information, and loyalty rewards (Step 908). The receipts can include itemized pricing, size selections, timestamps, store identifiers, discount codes, and fit-related notes derived from the Fit Recommendation Module 204. The system may additionally provide real-time shipment tracking links, estimated delivery windows, and post-purchase garment-care instructions.

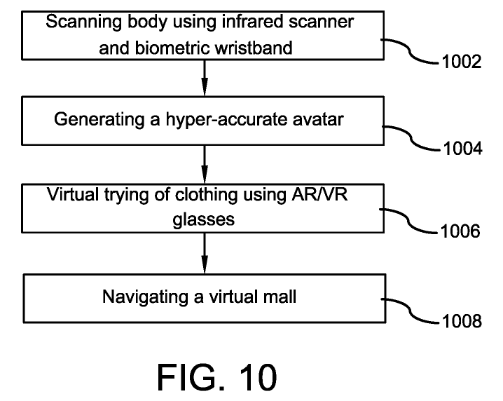

FIG. 10 illustrates a flow diagram depicting operational workflow of the virtual garment fitting and social shopping system of the present invention in accordance with the disclosed architecture. Initially, the system 100 performs body scanning using the infrared scanner and biometric wristband (Step 1002). In various embodiments, the ‘FitKey’ infrared scanner 104 captures depth frames, structured-light patterns, or point-cloud data representative of the user’s body shape and the ‘FitBand’ biometric wristband 106 captures posture vectors, motion data, skeletal alignment, and additional biometric or contextual information. The sensor inputs may be combined to generate a posture-corrected and noise-filtered volumetric dataset suitable for body-model fitting.

At step 1004, the system 100 generates a hyper-accurate avatar based on the scan data. The avatar generation process can include parametric body-model estimation, volumetric fusion, mesh deformation, body-shape optimization, texturing, rigging, and skeletal configuration performed by the avatar engine 202 on the cloud server 112 or in hybrid cooperation with the ‘FitScan’ App 102. The resulting avatar can include anatomical detail sufficient for garment-simulation accuracy, including joint articulation, deformation curves, and skinning weights that support realistic motion and cloth draping during virtual try-on.

The system then conducts virtual trying-on of clothing using AR/VR glasses such as the ‘FitLens’ device 110 (Step 1006). In some embodiments, the ‘FitLens’ device overlays digital or virtual garments onto the user’s physical body using passthrough AR or displays the avatar wearing selected outfits in a fully immersive VR environment. The AR/VR try-on process may incorporate garment simulation models generated by the fit recommendation module 204, including stretch analysis, drape computation, collision detection, and real-time fabric behavior adjustments.

At step 1008, the system 100 provide a virtual mall that enables the user to navigate the virtual mall using the generated avatar or through direct AR/VR interaction. Navigation may be performed using the ‘FitNav’ joystick or navigational controller 108, gesture-based controls detected by the ‘FitLens’ device 110, or touchscreen inputs provided within the ‘FitScan’ App 102. As the user moves through the virtual mall, the system may dynamically render storefronts, display product previews, update environmental lighting, and provide ‘FitGuide’-driven recommendations for stores, outfits, or style themes.

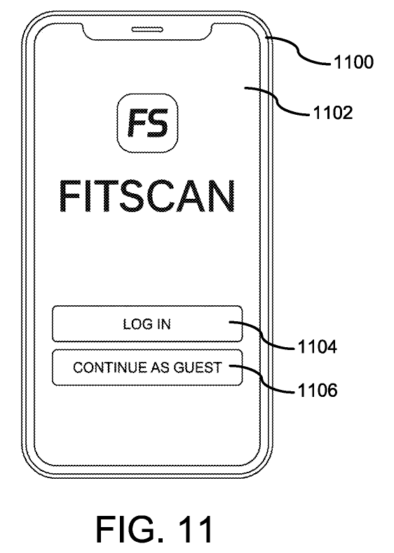

FIG. 11 illustrates an exemplary application entry interface displayed to a user on launching the ‘FitScan’ App in accordance with the disclosed architecture. As shown in FIG. 11, the interface may be displayed on a mobile electronic device 1100, which can include a smartphone, tablet, wearable display, or other computing device capable of executing the ‘FitScan’ software application.

The interface 1102 presents one or more account-access options, including a login button 1104 and a “continue as guest” option 1106. The login button 1104 may enable returning users to authenticate using credentials, biometrics, single sign-on integrations, or third-party identity providers. Authentication may enable retrieval of stored avatars, purchase histories, virtual mall preferences, garment-fit data, social-shopping connections, or previously generated lookbooks.

The guest-access option 1106 may enable a user to proceed without creating an account, permitting limited access to scanning, try-on previews, or non-synchronized navigation features while restricting access to advanced personalization and social functionalities.

In various embodiments, the application entry interface 1102 can include animations, loading indicators, privacy notices, or ‘FitGuide’ assistant prompts depending on system configuration. The splash screen 1102 may also establish wireless connections with accessory devices such as the ‘FitKey’ infrared scanner 104, the ‘FitBand’ biometric wristband 106, the ‘FitNav’ joystick or navigational controller 108, or the ‘FitLens’ AR/VR device 110.

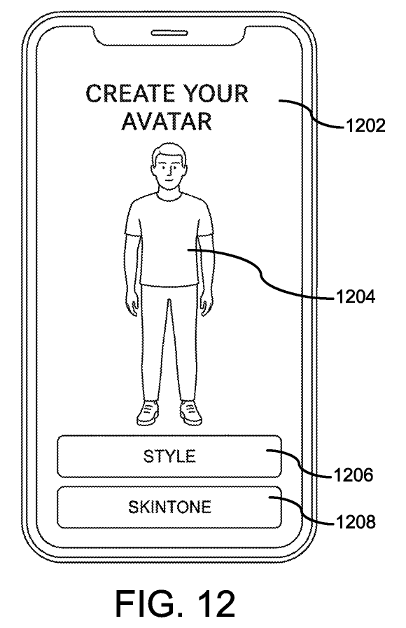

FIG. 12 illustrates one embodiment of an avatar-creation user interface displayed within the ‘FitScan’ application in accordance with the disclosed architecture. The interface 1202 prominently may display a representation of the avatar 1204. The avatar 1204 may initially be generated from body-scan data provided by the ‘FitKey’ infrared scanner 104 and the ‘FitBand’ biometric wristband 106.

The user may refine or customize the avatar using the interface 1202. The displayed avatar can include default styling, placeholder clothing, or initial proportions based on extracted body measurements. In some embodiments, the avatar 1204 is rendered as a simplified model during the customization process and later replaced with a high-resolution version for garment simulation and AR/VR environments.

The interface 1202 includes a style selection option 1206 and a skin-tone selection option 1208. The style option 1206 may enable the user to modify hairstyle, face shape, body proportions, or clothing presets. The skin-tone option 1208 can provide selectable swatches, slider adjustments, or automatically (i.e., autonomously) generated tones derived from user-provided images.

In various embodiments, the avatar-creation interface 1202 may also include additional features such as posture calibration prompts, facial-capture modules, garment-preview panels, or advanced editing options such as height adjustment, muscle definition, or accessory selection.

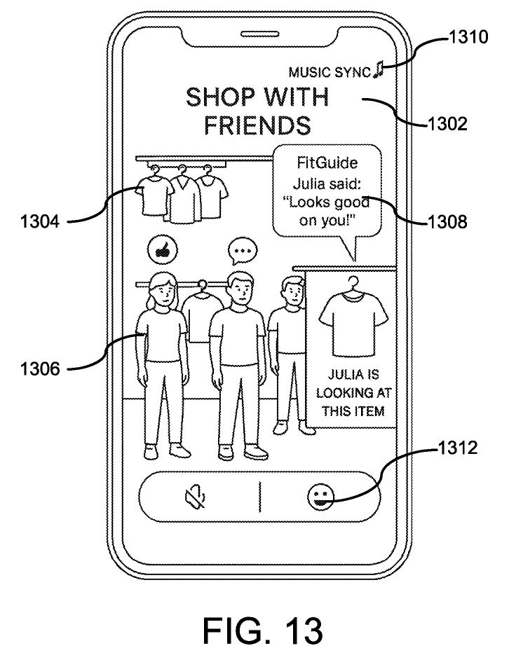

FIG. 13 illustrates an exemplary social shopping interface displayed by the ‘FitScan’ software application in accordance with the disclosed architecture. The screen 1302 includes a header region displaying a title such as “SHOP WITH FRIENDS,” indicating that the user is participating in a social, synchronized shopping session. The interface 1302 also includes a music synchronization indicator 1310 to indicate that background audio, playlists, or ambient soundtracks are being shared among users in the session to create a unified experience.

The interface further includes a garment rack or product-preview area 1304, which displays one or more garments currently being reviewed by members of the shopping group. The garments may be selected by any participant in the session, recommended by the ‘FitGuide’ assistant, or pulled from retail storefronts being visited.

A group of avatars 1306 are shown who are participating in the session. Each avatar may correspond to a different remote user and may be displayed along with identifying features, gestures, or presence indicators. The system may animate the avatars to reflect actions such as selecting items, reacting to garments, or navigating to different parts of a virtual store.

A ‘FitGuide’ message balloon 1308 appears within the interface, providing real-time contextual guidance or summarizing feedback from session participants. For example, the ‘FitGuide’ assistant may display statements such as “Julia said: ‘Looks good on you!’” to communicate social input collected from other users. In various embodiments, ‘FitGuide’ may also highlight the most-viewed garments, suggest alternative items, or provide fit explanations relevant to the ongoing conversation.

The interface 1302 provides interactive controls 1312, which can include a voice-chat button, reaction icons, messaging tools, or quick-access ‘FitGuide’ features. The controls enable users to communicate through text, voice, emoji reactions, or short-form feedback during the shared shopping session.

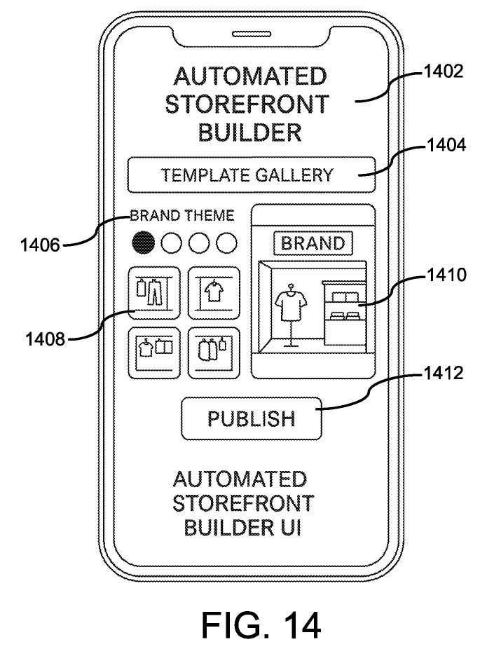

FIG. 14 illustrates one embodiment of an automated storefront-builder interface presented within the software application for enabling retailers to quickly configure and publish virtual storefronts inside the virtual mall environment. The interface 1402 displays a template-selection control 1404. The control 1404 enables retailers to browse a library of storefront templates, including minimalist layouts, boutique-style arrangements, grid-based product walls, or premium multi-panel storefront configurations. Selection of a template may update the storefront preview displayed in the interface.

The interface 1402 further includes a brand-theme customization region 1406, which can provide selectable color circles, palette presets, or theme swatches. The theme options may enable the retailer to apply brand-consistent colors to walls, signage, lighting accents, UI highlights, or product frames. A theme selection may automatically (i.e., autonomously) propagate color changes to the storefront preview 1410 and other user-facing visual elements.

A category-selection area 1408 is also displayed within the interface. The area 1408 enables retailers to assign product categories such as shirts, pants, shoes, accessories, outerwear, or specialty collections. Each category icon within region 1408 may correspond to a previously uploaded catalog of garments, and selecting a category may populate the storefront preview with representative items from that catalog. In some embodiments, the system may automatically (i.e., autonomously) recommend layout configurations based on category count, inventory size, or garment type.

The storefront preview panel 1410 displays a dynamically updated representation of how the final store will appear within the ‘FitScan’ virtual mall. The preview may show garment racks, mannequins, shelf arrangements, signage including the retailer’s brand name, and simulated lighting conditions. In various embodiments, the preview panel can support interactive zoom, rotation, or multi-angle viewing to assist retailers in verifying the final appearance of their store.

A publish button 1412 may trigger the retail integration module 206 to finalize the storefront configuration, validate asset mappings, optimize textures and meshes, and deploy the completed storefront into the virtual mall. Upon publishing, the system may also generate backend analytics-tracking identifiers, inventory-sync schedules, promotional hooks, or ‘FitGuide’-assisted merchandising metadata.

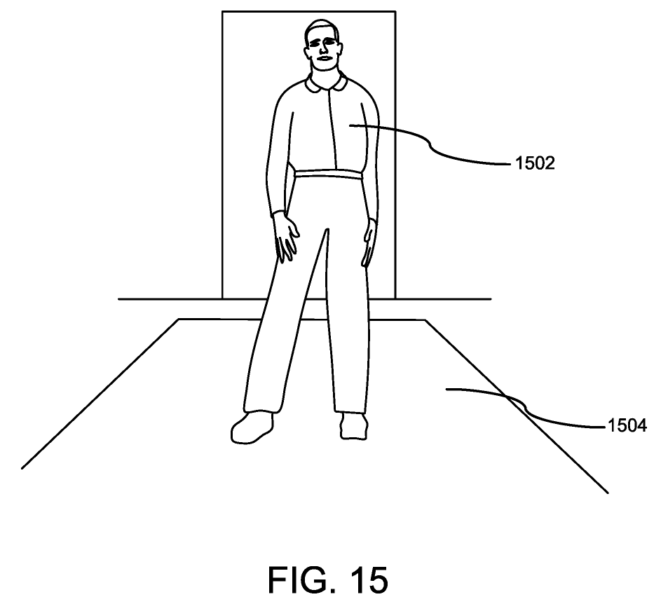

FIG. 15 illustrates one embodiment of a virtual runway presentation interface generated by the ‘FitScan’ system of the present invention during operation of the runway mode. As shown in FIG. 15, an avatar 1502 representing the user is displayed on a virtual runway 1504 within a digitally or virtually rendered fashion-show environment. The avatar 1502 may correspond to the high-resolution, fully rigged 3D model created using the avatar-generation processes described in FIG. 3. In some embodiments, the avatar 1502 is animated using skeletal controls and motion presets to simulate realistic walking, posing, garment drape, and character expressions.

The avatar 1502 may wear one or more garments digitally or virtually applied using cloth-simulation, cage-deformation, or physics-based draping algorithms executed by the ‘FitScan’ App 102 and/or the cloud server 112. The garments may be selected by the user, generated as part of a curated outfit sequence by the ‘FitGuide’ assistant, or sourced automatically (i.e., autonomously) from retailer catalogs imported using the retail integration module 206.

The virtual runway 1504 represents an immersive scene rendered by the ‘FitScan’ system to emulate a professional fashion-show environment. The runway 1504 can include animated lighting, spotlights, ambient audience silhouettes, reflective surfaces, environmental fog, or dynamic camera angles to enhance visual realism. In certain embodiments, the lighting conditions and background color palette may be adjusted automatically (i.e., autonomously) based on the colors, textures, or styles of the garments being showcased in order to optimize visual presentation.

During runway mode, the system may record or stream the presentation, enable friends to view the show remotely, synchronize music playback, or enable real-time outfit swapping. In some embodiments, the ‘FitGuide’ assistant can provide commentary or style insights during the runway sequence, helping users compare alternative looks or select the most complementary garment configurations.

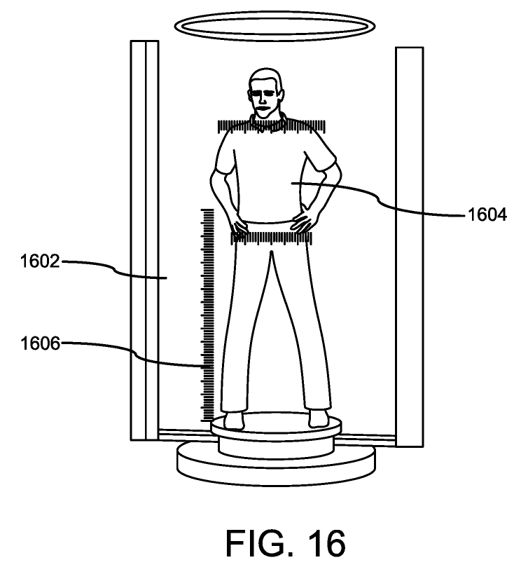

FIG. 16 illustrates one embodiment of a body-measurement capture interface generated by the ‘FitScan’ system during the scanning and avatar-creation process. As shown in FIG. 16, the system displays a 3D avatar 1604 standing within a virtual measurement environment 1602. The measurement environment 1602 can include vertical and horizontal reference scales 1606, alignment markers, or measurement overlays that correspond to anthropometric landmarks used by the system.

The visual elements enable the user to confirm correct posture, stance width, and body alignment. In some embodiments, the environment 1602 dynamically adjusts in response to ‘FitBand’ IMU posture readings, automatically (i.e., autonomously) correcting tilt, rotation, or uneven body orientation detected during the scan. The measurement environment may also simulate studio-quality lighting to enhance depth-capture accuracy.

The avatar 1604 represents a preliminary body model generated from raw scan data obtained using the ‘FitKey’ IR depth sensor and fused point-cloud frames. The avatar 1604 may update in real time as the system receives additional depth frames, biometric data, and skeletal adjustments.

The ‘FitGuide’ assistant may simultaneously provide prompts instructing the user to rotate, raise arms, adjust distance from the camera, or hold still while depth capture occurs. When the user maintains the correct stance, the measurement overlays may lock onto the avatar model and display confidence indicators based on data quality.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “virtual garment fitting and social shopping system”, “‘FitScan’ system”, and “system” are interchangeable and refer to the virtual garment fitting and social shopping system 100 of the present invention.

Notwithstanding the forgoing, the virtual garment fitting and social shopping system 100 of the present invention can be of any suitable configuration as is known in the art without affecting the overall concept of the invention, provided that it accomplishes the above stated objectives. One of ordinary skill in the art will appreciate that the virtual garment fitting and social shopping system 100 shown in the FIGS. are for illustrative purposes only, and that many other configurations of the virtual garment fitting and social shopping system 100 are well within the scope of the present disclosure. Although the dimensions of the virtual garment fitting and social shopping system 100 are important design parameters for user convenience, the virtual garment fitting and social shopping system 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A virtual garment fitting and shopping system comprising:
a software app;
an infrared scanner;
a biometric wristband;
a navigation controller; and
a cloud server;
wherein said software app executable on a mobile electronic device selected from the group consisting of a tablet computer, a laptop, a smart mirror, an AR visor, and a VR wearable headset;
wherein said software app configured to provide multiple user interfaces selected from the group consisting of body-scanning, avatar creation, garment try-on, virtual mall navigation, social shopping, and runway presentation modes to generate measurement-accurate 3D avatars for performing virtual garment try-on;
wherein said software app can communicate with said infrared scanner, said biometric wristband, said navigation controller, and said cloud server using one or more communication protocols selected from the group consisting of Bluetooth Low Energy (BLE), Wi-Fi, NFC, ultra-wideband (UWB), and near-field infrared signaling;
wherein said infrared scanner is an infrared depth-capture device;
wherein said infrared scanner comprises one or more selected from the group consisting of an IR emitter, an IR camera, a calibration module, an inertial sensor, and a microcontroller configured to perform preliminary depth fusion, noise filtering, and frame bundling before transmitting data to said software app;
wherein said software app synchronizes sensor data using timestamps, packet-level metadata, or low-latency compression techniques to improve accuracy during 3D scanning and AR rendering;
wherein said infrared scanner captures images selected from the group consisting of structured-light projection patterns, time-of-flight depth pulses, and speckle-pattern illuminations to capture depth images, volumetric slices, and point-cloud frames; and
further wherein said infrared scanner transmits diagnostic metrics to said software app selected from the group consisting of temperature, battery level, calibration status, and IR exposure parameters.

2. The virtual garment fitting and shopping system of claim 1, wherein said biometric wristband is a wearable device configured to transmit posture-related and physiological data to said software app.

3. The virtual garment fitting and shopping system of claim 2, wherein said biometric wristband comprises one or more sensors selected from the group consisting of a 6-axis inertial measurement unit (IMU), a magnetometer, a photoplethysmography (PPG) sensor, a skin-temperature sensor, and a galvanic skin-response sensor.

4. The virtual garment fitting and shopping system of claim 3, wherein said biometric wristband comprises skeletal-alignment vectors, wrist orientation, and motion-stability indicators to correct body-scan data for posture deviations, leaning, twisting, and misalignment conditions during scanning.

5. The virtual garment fitting and shopping system of claim 1, wherein said navigation controller comprises a handheld wireless controller featuring a multi-axis joystick, one or more buttons, and haptic response elements for user interaction with one or more of selected from the group consisting of virtual mall environments, virtual retail storefronts, and social shopping rooms with said software app to navigate said virtual mall environments, participate in shared multi-user shopping sessions, and interact with said virtual retail storefront through automated storefront integration.

6. The virtual garment fitting and shopping system of claim 1, wherein said VR wearable headset comprises one or more sensors selected from the group consisting of stereoscopic displays, head-pose tracking sensors, eye-tracking sensors, forward-facing cameras for passthrough AR, and hand-tracking modules configured to generate real-time occlusion masks, depth-aligned overlays, and avatar-anchored garment projections.

7. The virtual garment fitting and shopping system of claim 1 further comprising a virtual assistant comprising a multimodal digital assistant configured to provide real-time guidance, coaching, recommendations, and contextual automation, wherein said virtual assistant operates as a software subsystem executed by said software app to receive inputs from multiple system components selected from one or more of the group consisting of said posture vectors, said biometric indicators, said navigation inputs, and said spatial-tracking.

8. The virtual garment fitting and shopping system of claim 7, wherein said virtual assistant comprises a personalized fit-recommendation engine using one or more selected from the group consisting of user measurements, garment metadata, historical fit scores, fabric stretch properties, virtual try-on results, and retailer-specific size charts to recommend an appropriate size for a user.

9. A method of virtual garment fitting, the method comprising the steps of:
providing a software app, an infrared scanner, a biometric wristband, a navigation controller, and a cloud server;
executing said software app on a mobile electronic device selected from the group consisting of a tablet computer, a laptop, a smart mirror, an AR visor, and a VR wearable headset;
wherein said software app configured to provide multiple user interfaces selected from the group consisting of body-scanning, avatar creation, garment try-on, virtual mall navigation, social shopping, and runway presentation modes;
wherein said software app can communicate with said infrared scanner, said biometric wristband, said navigation controller, and said cloud server using one or more communication protocols selected from the group consisting of Bluetooth Low Energy (BLE), Wi-Fi, NFC, ultra-wideband (UWB), and near-field infrared signaling;
wherein said infrared scanner comprises one or more selected from the group consisting of an IR emitter, an IR camera, a calibration module, an inertial sensor, and a microcontroller configured to perform preliminary depth fusion, noise filtering, and frame bundling before transmitting data to said software app;
wherein said software app synchronizes sensor data using timestamps, packet-level metadata, or low-latency compression techniques to improve accuracy during 3D scanning and AR rendering;
scanning a user’s body with said infrared scanner and said biometric wristband; and
generating a measurement-accurate 3D avatar of a user for performing virtual garment try-on.

10. The method of virtual garment fitting of claim 9, wherein said infrared scanner captures images selected from the group consisting of structured-light projection patterns, time-of-flight depth pulses, and speckle-pattern illuminations to capture depth images, volumetric slices, and point-cloud frames.

11. The method of virtual garment fitting of claim 9 further comprising the step of transmitting diagnostic metrics from said infrared scanner to said software app selected from the group consisting of temperature, battery level, calibration status, and IR exposure parameters.

12. The method of virtual garment fitting of claim 9, wherein said infrared scanner is an infrared depth-capture device.

13. The method of virtual garment fitting of claim 11, wherein said infrared scanner captures images selected from one or more of the group consisting of depth frames, structured-light patterns, and point-cloud data representative of the user’s body shape.

14. The method of virtual garment fitting of claim 13, wherein said biometric wristband captures one or more of the group consisting of posture vectors, motion data, and skeletal alignment.

15. The method of virtual garment fitting of claim 9, wherein said generating said measurement-accurate 3D avatar comprises data selected from one or more of the group consisting of parametric body-model estimation, volumetric fusion, mesh deformation, body-shape optimization, texturing, rigging, and skeletal configuration.

16. The method of virtual garment fitting of claim 15 further comprising the step of virtually trying-on of clothing using said VR wearable headset, wherein said VR wearable headset displays said measurement-accurate 3D avatar wearing selected clothing.

17. A method of virtual garment fitting and shopping, the method comprising the steps of:
providing a software app, an infrared scanner, a biometric wristband, a navigation controller, and a cloud server;
executing said software app on a mobile electronic device selected from the group consisting of a tablet computer, a laptop, a smart mirror, an AR visor, and a VR wearable headset;
wherein said software app configured to provide multiple user interfaces selected from the group consisting of body-scanning, avatar creation, garment try-on, virtual mall navigation, social shopping, and runway presentation modes;
wherein said software app can communicate with said infrared scanner, said biometric wristband, said navigation controller, and said cloud server using one or more communication protocols selected from the group consisting of Bluetooth Low Energy (BLE), Wi-Fi, NFC, ultra-wideband (UWB), and near-field infrared signaling;
wherein said infrared scanner comprises one or more selected from the group consisting of an IR emitter, an IR camera, a calibration module, an inertial sensor, and a microcontroller configured to perform preliminary depth fusion, noise filtering, and frame bundling before transmitting data to said software app;
wherein said software app synchronizes sensor data using timestamps, packet-level metadata, or low-latency compression techniques to improve accuracy during 3D scanning and AR rendering;
scanning a user’s body with said infrared scanner and said biometric wristband;
generating a measurement-accurate 3D avatar of a user for performing virtual garment try-on; and
navigating a virtual mall using said measurement-accurate 3D avatar and said navigation controller, wherein said virtual mall provides options selected from the group consisting of virtually rendered storefronts, displayed product previews, updated environmental lighting, and provided recommendations of garment try-ons.

18. The method of virtual garment fitting and shopping of claim 17, wherein said biometric wristband is a wearable device configured to transmit posture-related and physiological data to said software app.

19. The method of virtual garment fitting and shopping of claim 18, wherein said biometric wristband comprises one or more sensors selected from the group consisting of a 6-axis inertial measurement unit (IMU), a magnetometer, a photoplethysmography (PPG) sensor, a skin-temperature sensor, and a galvanic skin-response sensor.

20. The method of virtual garment fitting and shopping of claim 19, wherein said navigation controller comprises a handheld wireless controller featuring a multi-axis joystick, one or more buttons, and haptic response elements for user interaction with one or more of selected from the group consisting of said virtual mall, said virtually rendered storefronts, and social shopping rooms with said software app to navigate said virtual mall, participate in shared multi-user shopping sessions, and interact with said virtually rendered storefronts.
